(19) United States
(12) Patent Application Publication
(10) Pub. No.: US 2026/0291427 A1
(43) Pub. Date: Sep. 24, 2026

(54) SOLAR MOUNTING ASSEMBLY

(71) Applicant: SWIF Solar LLC, Portland, OR (US)

(72) Inventor: Steve Leslie, Hood River, OR (US)

(73) Assignee: SWIF Solar LLC, Portland, OR (US)

(21) Appl. No.: 19/694,235

(22) Filed: Jun. 1, 2026

Related U.S. Application Data
(63) Continuation-in-part of application No. 18/582,546, filed on Feb. 20, 2024.
(60) Provisional application No. 63/617,371, filed on Jan. 3, 2024.
(60) Provisional application No. 63/815,380, filed on May 30, 2025.

(51) Int. Cl. H02S 30/10; F16B 2/06; H02S 20/23

(52) U.S. Cl. CPC H02S 30/10; F16B 2/065; H02S 20/23

(57) ABSTRACT

Apparatuses, systems and methods for mounting solar power arrays to a supporting surface in a manner that facilitates access to the area beneath the solar power array.

### CROSS REFERENCE TO RELATED APPLICATIONS

The present application claims the benefit of U.S. Provisional Patent Application No. 63/815,380 filed on May 30, 2025. The present application is also a continuation-in-part of U.S. patent application Ser. No. 18/582,546 filed on Feb. 20, 2024, which claims the benefit of U.S. Provisional Patent Application No. 63/617,371 filed on Jan. 3, 2024, the contents of which are incorporated herein by reference in their entirety.

### BACKGROUND

The subject matter of this application relates to mounting assemblies for solar panels.

Solar power collection systems are used for a variety of purposes e.g., as utility interactive power systems, power supplies for remote or unmanned sites, etc. Solar power systems are also used in residential and commercial environments where a solar power array is mounted to a roof of a building to be supplied power by the array, or sometimes mounted on the ground proximate a building to be supplied power by the array. In general terms, a solar energy collection system typically has a number of solar panels, each comprising an array of photovoltaic (PV) power cells, where the solar panels are arranged in rows and/or columns and are mounted on a structure or on the ground. The solar panels are oriented to optimize the PV cells'energy output to suit the particular system design requirements. Solar panels may be mounted on a fixed structure, with a fixed orientation and fixed tilt, or may be mounted on a tracking structure. A solar energy collection system can have a capacity from a few kilowatts to a hundred kilowatts or more, depending upon the number of PV cells in the array of solar panels, and can be installed wherever there is a reasonably flat area with exposure to the sun for significant portions of the day.

As just noted, some building structures have been outfitted with solar panels on their flat or pitched rooftops to obtain electricity generated from the sun. Though these “add-on” solar power arrays can be installed on any type of roofing system, such arrays are ex-pensive since they are typically assembled on-site rather than in a factory, and also typically require separate substructures to support the solar panels that form the solar power array. These substructures are required for several reasons. First, solar panels are heavy, and the substructure is needed to support the weight of the solar power array. Second, solar power arrays are subject to static loads (e.g., the weight of the system itself, snow and ice, etc.) as well as dynamic forces from wind and seismic loading, and because the solar panels are rigidly connected to each other, the connection points are subject to substantial shear stresses and bending moments that can damage the array. The supporting substructure must be able to absorb and disperse these stresses/moments. For these reasons, installing a solar power array on, for example, a roof of a residential and commercial building involves a substantial capital in-vestment that must be recovered over time by the value of the power generated by the solar panel array over the lifetime of the solar panels comprising the array.

Unfortunately, many solar power arrays installed on the roofs of commercial and residential buildings do not achieve the financial benefits envisioned upon installation, often because the lifetime of the solar panels extend beyond the lifetime of the roof upon which they are installed. Solar power arrays extend over a significant area of a roof, and when the section of roof underneath a solar power array needs to be repaired or replaced, the solar power array needs to be removed and it is often not economical to incur the added costs of re-installing the array over the repaired/replaced roof given the remaining lifetime of the solar power array. Thus, in such circumstances the solar panels are simply discarded despite their remaining lifetime.

What is desired, therefore, are improved substructures for solar power arrays, and methods for installing the same, that reduce the capital expense of installing and maintaining the solar array, and that accommodate the repair and/or replacement of the roof without having to repair the substructure or PV arrays.

### BRIEF DESCRIPTION OF THE DRAWINGS

For a better understanding of the invention, and to show how the same may be carried into effect, reference will now be made, by way of example, to the accompanying drawings, in which:

FIGS. 1A and 1B each show respective embodiments of solar panel arrays having an improved support substructure as described in the present specification, comprising a plurality of standoffs and a plurality of rails.

FIG. 2A shows alternate and novel rails that may be used in the substructure of FIGS. 1A and 1B.

FIG. 2B shows two rails spliced together.

FIG. 3 shows a cross section of a solar panel array having the substructure disclosed in the present specification.

FIGS. 4A and 4B each show cross section of a single rail connected to a standoff and a spliced rail connected to a standoff, respectively.

FIG. 5A shows an end connector assembly for connecting the ends of the rails of the disclosed substructure to supporting solar panels.

FIG. 5B shows the end-connector assembly of FIG. 5A connecting a solar panel to the end of a rail.

FIG. 6A sows a mid-connector assembly connecting two solar panel to a central section of a rail.

FIG. 6B shows a cross section of the mid-connector assembly of FIG. 6A.

FIG. 7 shows a novel embodiment of mid-connector assembly having an aperture having corners.

FIG. 8 shows a cross-section of a standoff of FIGS. 1A and 1B connected to the structure of a roof.

FIGS. 9 and 10 show an alternate embodiment of a substructure for a solar panel array, having a plurality of cross supports for, and transverse to, the rails that support a plurality of solar panels.

FIG. 11 shows the cross supports of FIGS. 9 and 19 supported by standoffs.

FIGS. 12 and 13 show a second alternate embodiment of a substructure for a solar panel array, where a standoff may support a plurality of cross supports for, and transverse to, the rails that support the solar panels.

FIG. 14A shows a novel clamp mechanism for securing two solar panel frames to a supporting rails structure, without solar panels in the frame.

FIG. 14B shows the clamp mechanism of FIG. 14A with a solar panel inserted into one of the frames.

FIG. 15 shows a cross section of the clamp mechanism of FIGS. 14A and 14B.

FIG. 16 shows an embodiment of a standoff filled with closed-cell foam.

### DETAILED DESCRIPTION

Disclosed in this specification are improved substructures for solar panel arrays mounted to, or that may be mounted to, a roof of a residential or commercial building. Also disclosed in this specification are novel components of such substructures. Those of ordinary skill in the art will appreciate, however, that the disclosed substructures and their components may also be used to mount solar arrays on the ground.

As noted previously, solar power arrays require a supporting substructure to both support the weight of the solar panels and also to absorb and disperse structural stresses and bending moments due to dynamic forces applied to the array by e.g., wind. Existing substructures for solar power arrays comprise a heavy and extensive cross-brace network of supports that undergird the array of solar panels.

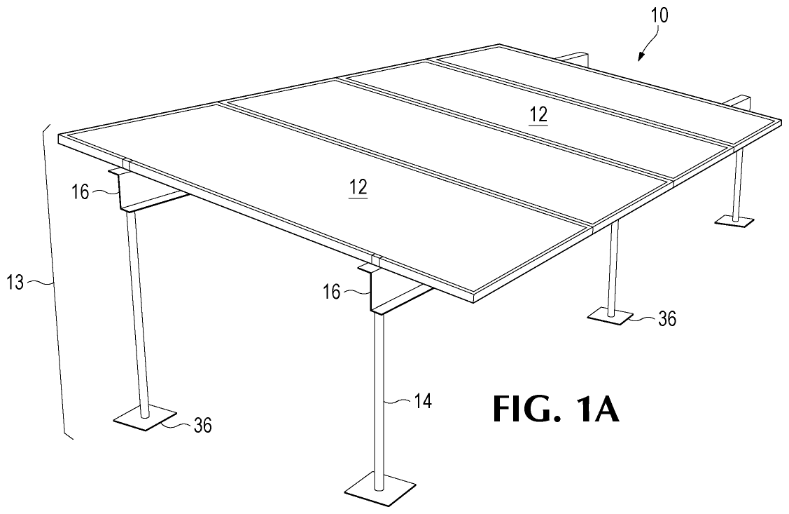

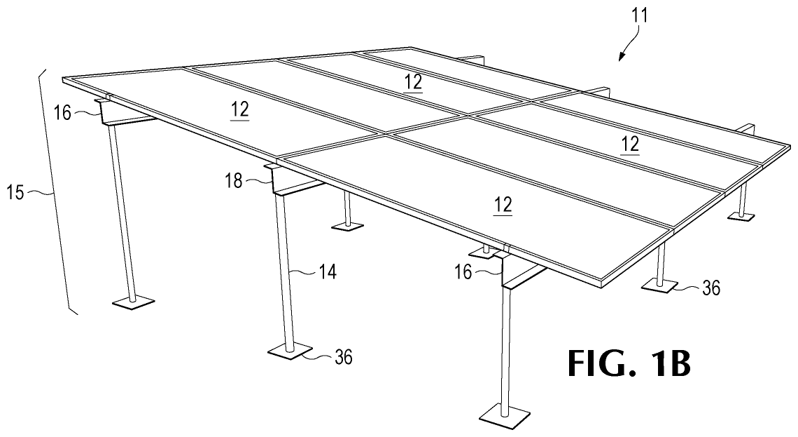

The present specification discloses an improved substructure for a solar panel array that eliminates the need for such a cross-brace structure. Specifically referring to FIG. 1A, a solar power assembly 10 may comprise a plurality of panels 12 supported by a substructure 13 that includes a plurality of standoffs 14. The substructure 13 is shown as supporting a single row of panels 12. Alternatively, as seen in FIG. 1B, some embodiments of the present disclosure may include a solar power assembly 11 with a substructure 15 that supports two (or more) rows of solar panels.

The solar power assemblies 10 and 11 are preferably adaptable to suit a widely-varying range of power requirements for a particular building or project by adjusting the size of the array i.e., adding additional solar panels to the rows or columns of the array as may be required. To this end, the substructures 13, 14 show two unique features disclosed in the present specification that facilitate such adaptability. First, substructures 13, 14 may include two alternate types of rails 16 and 18 that connect the standoffs 14 to the solar panels 12. Rail 16 is configured to support one or more solar panels 12 that are arranged along a single row defined along the length of the rail 16. In other words, rails 16 are configured to provide structural support for solar panels 12 arranged along the single dimension that is aligned along the length of the rail. Conversely, rails 18 are each configured to provide structural support for solar panels arranged along two such rows, meaning that the rails 18 each support solar panels 12 arrayed in two dimension-one along the length of rail 18 and one transverse to the length of rail 18.

Second, each of the rails 16 and 18 are configured to be spliced to another rail when needed to extend the rows of the solar power array. Specifically, each of the rails 16 and 18 may be formed of pressed or rolled steel (or other appropriate metal or material) to form a generally Z-shaped cross section, which facilitates one rail 16, 18 nesting with another rail 16 and 18 along an overlapping portion of the two rails. The overlapping or spliced rails 16, 18 may then be rigidly connected to each other to thereby extend the length of a support for a row of solar panels 12.

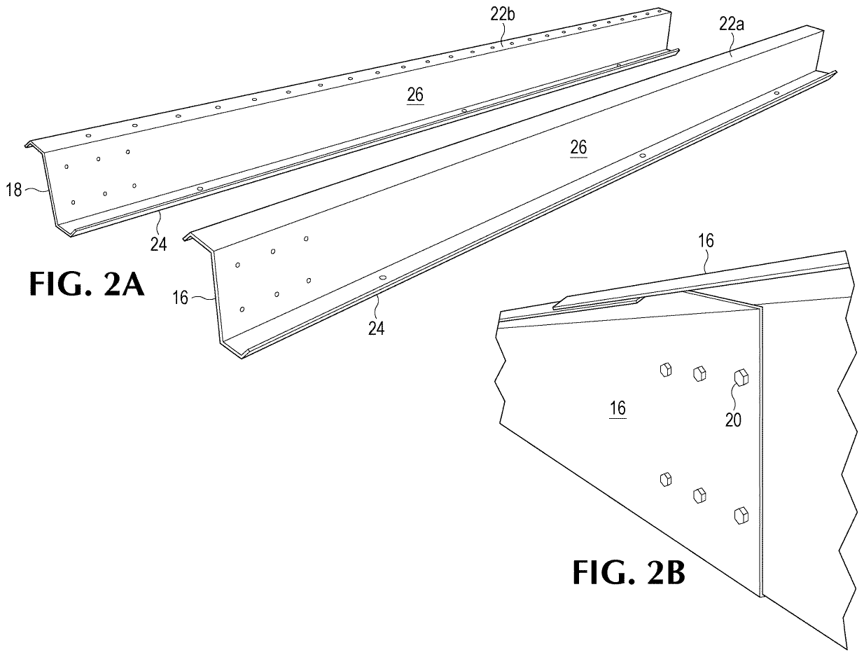

FIGS. 2A and 2B show each of these unique features. Specifically, FIG. 2A shows a rail 16 and a shared rail 18. Each of the rails 16 and 18, as noted above, may be formed as a generally Z-shaped beam in cross section, where a web 26 connects a top flange (flange 22a for rail 16 and flange 22b for shared rail 18) to a bottom flange 24 of rail 16, 18. The bottom flange 24 extends from the web 26 in a direction opposite to that of the flange 22a, 22b to thereby form the Z-shaped cross section. As can easily be appreciated, and seen in FIG. 2B, this shape permits each of the rails 16, 18 to be spliced to other such rails. In some embodiments, to facilitate such splicing, apertures 20 may be pre-cut into the web 26 at the one end of the rails 16, 18 to guide bolts that connect the spliced rails. In a preferred embodiment only one end of the rails 16, 18 are fabricated with pre-cut apertures. This facilitates the adaptability of the spliced rails to different sizes of solar power arrays as the length of the overlap may be adjusted variably, rather than incrementally to match apertures in one rail to those in another. Also, in such embodiments, self-drilling bolts may be guided by apertures 20 in one rail 16, 20 to drill into the structure of another spliced rail 16, 18 to provide structural strength to the spliced connection. However, those of ordinary skill in the art will also appreciate that apertures 20 may be cut into each end of the rails 16, 18 if desired. Similarly, those of ordinary skill in the art will appreciate that, although the Z-shape of the rails 16, 18 provide structural benefits similar to I-beams, i.e., enhancing bending resistance due to the concentration of material at the top and bottom flanges, some embodiments of the disclosed flanges 16, 18 may omit the lower flange 24.

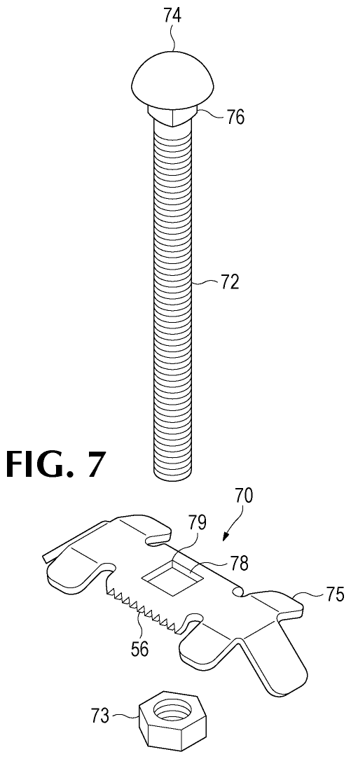

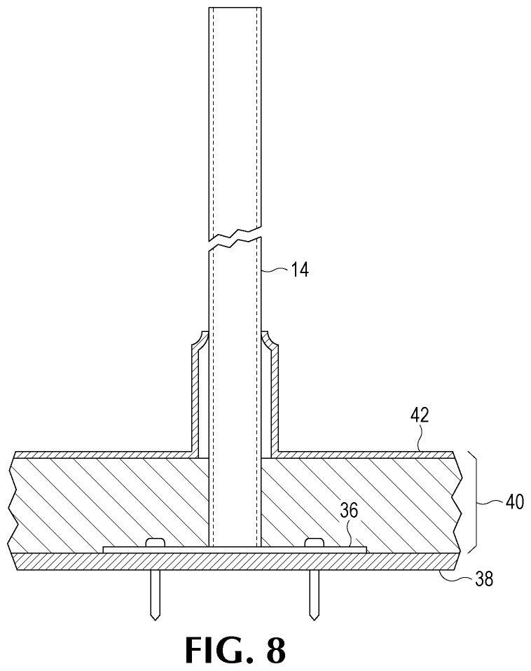

Also, as can be seen in FIG. 2A, apertures 28 may optionally be pre-cut into the top flange 22b of shared rail 18. These apertures facilitate the rigid interconnection of two different solar panels 12 shared across the transverse direction of the shared rail 18. Thus, referring again to FIG. 1B, the two solar panels 12 that rest on shared rail 18 may be positioned to provide an intervening gap that allows access to the apertures 28, which may then be used to guide respective bolts of novel mid-connectors, which will be discussed with respect to FIGS. 6A, 6B, and 7 later in this specification. These mid-connectors rigidly secure the two solar panels 12 to each other and to the shared rail 18. As will be appreciated by those of ordinary skill in the art, however, in some embodiments shared rail 18 may not include such apertures 28, and in such embodiments the shared rail may itself be structurally indistinguishable from rail 16, such that the shared rail is distinguished only by its placement and function in the solar power array i.e., by supporting multiple solar panels each arranged relative to each other transversely across the flange 22b of rail 18. Thus, the foregoing features of the standoffs 14 along with the rails 16, 18 allow for the easy and efficient scaling the substructures 13, 15 to the power and size required of the solar power assembly being installed.

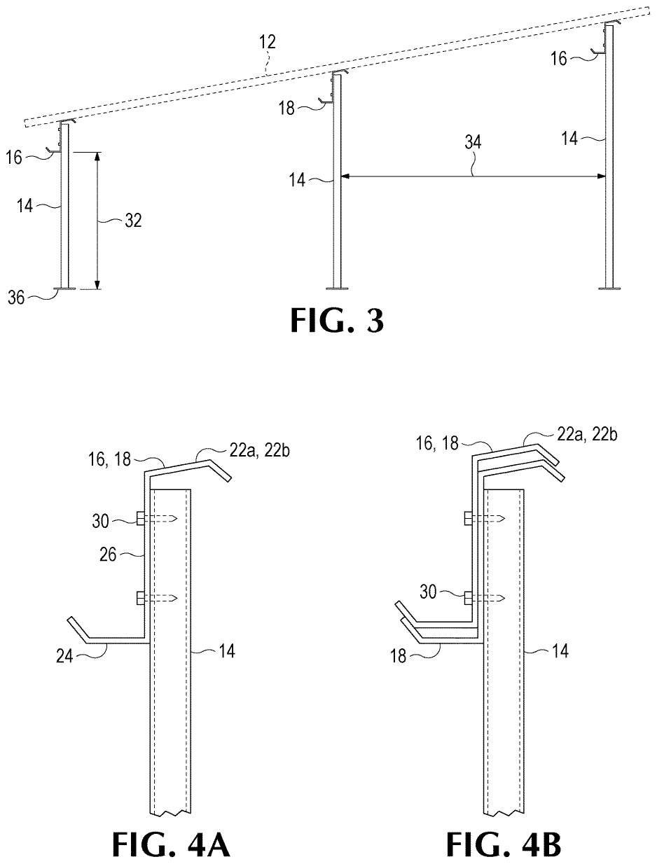

Referring to FIGS. 3, 4A and 4B, a substructure for a solar power array assembled using the disclosed standoffs 14 and rails 16, 18 achieve features and benefits that improve over existing such substructures. Specifically, the rails 16, 18 may be attached at the top portion of the standoffs 14, and by two bolts 30 spaced vertically from each other. This configuration achieves several benefits. First, the dual connection of the rails 16, 18 to the standoffs 14 provides a connection that transfers vertical and lateral loads from the solar panels to the standoffs in a simple manner. The standoffs are designed as cantilevered-columns to resist axial load as well as the lateral loads imparted by the solar panels. As cantilevered columns, the standoffs do not require cross-bracing. Added in-plane bending stiffness via frame action is also created by the rail-to-standoff connection that creates moment frames.

Second, by removing the need for such an extensive cross-brace structure, it becomes far easier to access the space underneath the solar panels 12. For example, some solar panel arrays are double-sided so as to attempt to capture energy from reflected light, and the space provided by the disclosed substructures facilitates any necessary maintenance/cleaning of such installations. More importantly, the open space beneath the solar panels 12 provided by the disclosed systems and methods allow maintenance and even replacement of a roof that supports a solar power array without removing or disassembling that array. As already noted, with existing solar power arrays mounted on roofs of buildings, when repair or replacement of the roof is needed, the solar panel array must typically be removed and is often discarded. The systems and methods disclosed in this specification therefore permit solar power arrays to operate over their full lifetime, even when mounted on rooftops or other structures that have less life than the solar power array.

Also, as can be seen in FIG. 3, the solar power array comprises solar panels 12 that are tilted upwards at an angle. This upward tilt is usually desired to increase the amount of solar energy incident on the panels, since in most terrestrial locations even under noonday sunshine on the summer solstice the sun is not directly overhead. Therefore, in preferred embodiments, the standoffs 14 are of varying height to accommodate the desired tilt, which may vary in magnitude based upon factors such as latitude, etc. In preferred embodiments, the standoffs 14 in a solar power installation may each have a minimum height of six inches and eight feet, and in still more preferred embodiments, the standoffs in a solar power array may have a minimum height of one foot. In still other preferred embodiments, at least one row of standoffs 14 have a height of at least 18 inches and in other embodiments at least two feet. In some preferred embodiments, the height of the standoffs 14 is configured to permit at least one of repair and replacement of a roof beneath the solar panels 12 without removing those panels.

Also to this end, the standoffs may define a vertical section 14 between the foot 36 of the standoff and the lower flange of the rail 16, 18 and may also define a horizontal distance 34 between successive standoffs, measured at a location within the vertical section 32 of the respective standoffs. In preferred embodiments, more than 50% of the distance 34 is free from obstruction. In other preferred embodiments, more than 75% of the distance 34 is free from obstruction and in still other preferred embodiments, more than 90% of the distance 34 is free from obstruction. In some embodiments, the vertical section 14 extends at least 50% of the height of the standoff 14 and in still other preferred embodiments, the vertical section 14 extends at least 80% of the height of the standoff 14.

Furthermore, the rails 16, 18 may preferably have an upper flange 22a, 22b that is also tilted at a magnitude to accommodate the desired angle at which the solar panels ate to tilt. In preferred embodiments, the angle of tilt of the flange 22a, 22b relative to the web is greater than 90 degrees and less than 150 degrees. Furthermore, in some preferred embodiments, the foot 36 of the standoffs 14 are also tilted to accommodate the pitch of a roof, at an angle that may range from zero to 15 degrees relative to horizontal.

Referring specifically to FIG. 4B, each of the rails 16, 18 preferably are fashioned of material that is sufficiently flexible to accommodate splicing two such rails together at their ends. Thus, while FIG. 4B shows a gap between the two spliced rails, this gap is exaggerated in this diagram; in actuality, in preferred embodiments the two rails are flush with each other in the spliced region due to the flexibility and resiliency of the rails 16, 18.

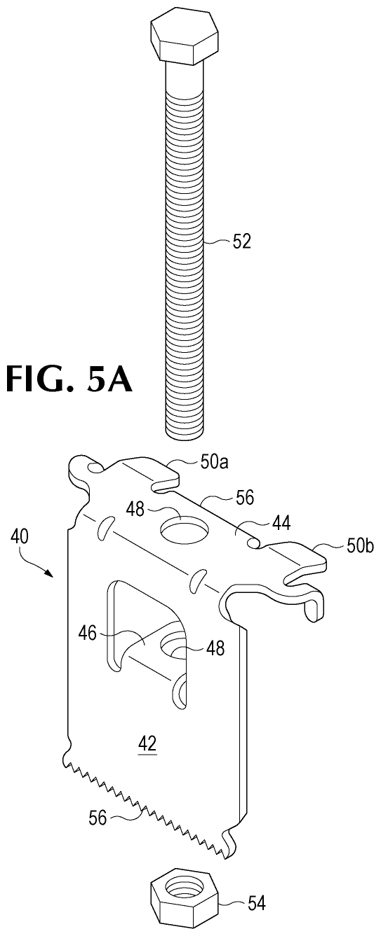

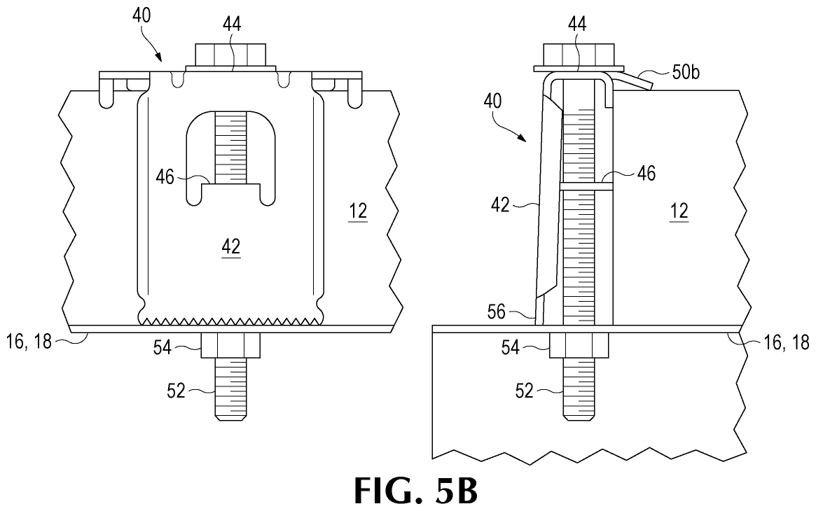

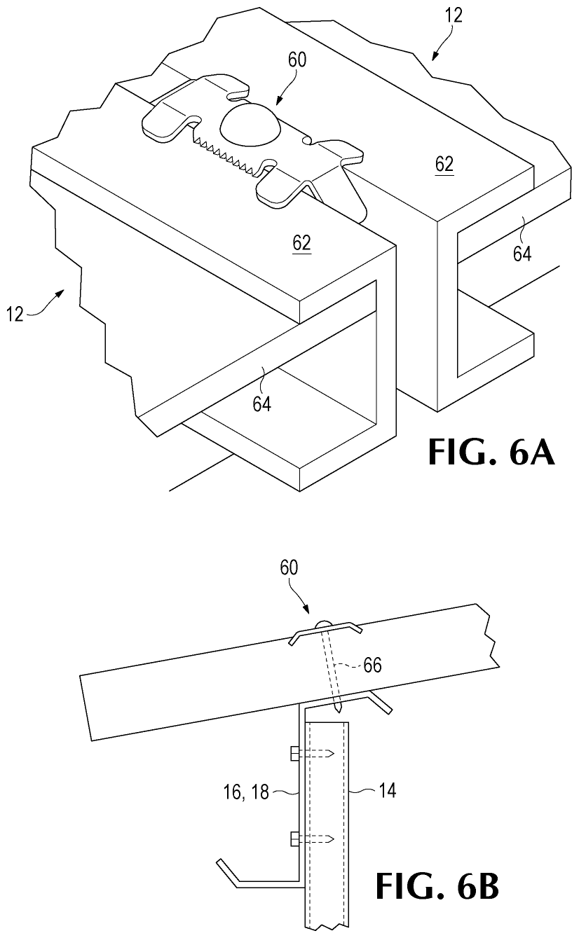

FIG. 5A shows an exemplary end connector 40 used to connect the end of a rail 16, 18 to a frame of a respective solar panel 12. The end connector 40 is generally L-shaped with a side member 42 generally orthogonal to a top member 44 and also generally orthogonal to a tongue 45 parallel to, and below the top member 44. Two parallel bolt holes 48 are formed in each of the top member 44 and tongue 46 to jointly receive a bolt 52. The end connector 40 has two downwardly angled tabs 50a and 50b extending from the top member 44. Referring also to FIG. 5B, the end connector 40 secures a panel 12 to a rail 16, 18 by positioning the connector 40 adjacent the panel 12 such that the tabs 50a and 50b press down on the top of the panel 12. The bolt 52 is fitted through the apertures 48 and extends through the rail 16, 18. In some embodiments, the bolt 52 is a self-drilling bolt that may pierce the rail 16, 18, while other embodiments may have pre-formed holes in the rails 16, 18. The nut 54 is used to tighten the end clamp 40 and thereby secure the solar panel 12 to the rail 16, 18. In some embodiments, the end clamp 40 may include teeth 56 that puncture any anodized coating of frames of the solar panels 12 and also the connected rail 16, 18 to provide a ground path for spurious electrical currents (e.g., lightning) so that the PV cells of the solar panels 12 are insulated and not damaged.

The procedure just described to use end clamps to fasten a solar panel to a rail 16, 18 is relatively easy given the proximity of the solar panel 12 to the end of the rails 16, 18. However, solar panels also need to be secured to each other and to a rail 16, 18 at locations that are not close to the end of the array, and this presents more difficulty. For example, as can be seen in FIGS. 6A and 6B, a mid-clamp 60 in conjunction with a bolt 66 is used to secure two solar panels 12 to each other, as well as to a rail 16, 18. If the mid-clamp 60 were proximate an edge of the solar power array, then during installation it would be relatively easy to use both hands to both turn the bolt and retain the nut in a fixed position (or vice versa) so as to tighten the assembly, but unfortunately solar panels 12 need to be secured to each other at locations far away from the edge of the array, making it difficult to sufficiently tighten the bolt.

Referring to FIG. 7, discloses is a novel mid-clamp 70 that addresses the limitations just described. Specifically, the mid-clamp 70 may define an aperture 78 configured to receive the threaded end 72 of a bolt 74 that engages with a nut 73. Similar to the end clamp 40, the mid-clamp 60 includes tabs 75 that bear down on the respective solar panels to either side of the mid clamp 60 as the bolt 74 is rotated relative to the nut 73, so as to secure the solar panels to each other and to the underlying rail 16, 18. However, the mid-clamp 70 is designed to be tightened using only one hand that rotates the nut 73 using e.g., a wrench. This feature is achieved because the mid clamp 70 defines an aperture 78 having at least one corner or edge 79 that locks the inserted bolt 74 against rotation. Thus, as can be seen in FIG. 7, where a bolt 74 includes a head 76 that matingly engages within the cornered aperture 78, the bolt 74 cannot rotate as the nut 73 is turned to tighten the bolt. Those of ordinary skill in the art will appreciate that, although the aperture 78 is formed as a square, other edged shapes are possible e.g., triangular, pentagonal, etc.

As noted earlier in this specification, embodiments of the disclosure include solar power arrays that are capable of being mounted to a roof of a building in a manner that enables the roof to be repaired or replaced without removal or disassembly of the solar power array. Referring to FIG. 8, for example, a standoff 14 with its foot 36 may be may be affixed to the structure 38 of a building upon which the roof 40 is supported. A roof typically comprises a structural layer 40 including an underlayment or water barrier 42 upon which shingles or other protective material is secured. The purpose of the underlayment is to provide an additional sealing layer to protect the roof against the ingress of moisture, and therefore the underlayment is typically made of a flexible material so that it may be wrapped upwards around vents, chimneys, and other structures of the building around which a roof is constructed. The underlayment 42 may therefore extend around and protect the standoff 14 against the ingress of moisture just as it would a vent, etc. More importantly, the repair and/or replacement of a roof may be performed around the standoff 14 while it is still connected to the structure 38 of the building as if it were another vent, chimney, etc. Furthermore, because embodiments disclosed herein eliminate the need for an extensive cross-brace structure to support the solar power array, there is sufficient room beneath the solar power array to complete the repairs/replacement while the solar power array remains attached to the building.

The solar panel assemblies previously described are supported by substructures comprising a plurality of elongate, parallel rails 16, 18 that in turn support the solar panels. The elongate, parallel rails are themselves supported above a roof surface (or above ground) by standoffs 14. The standoffs 14 are spaced from each other by a distance that provides ad-equate structural support for the parallel rails i.e., to prevent the rails from bowing under the combined weight of the beams themselves and the solar panels they support.

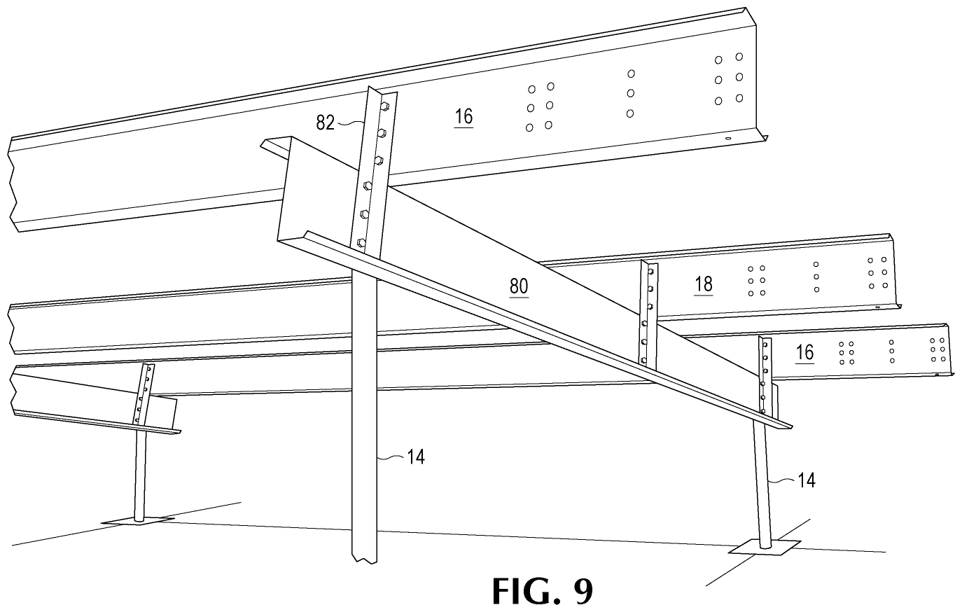

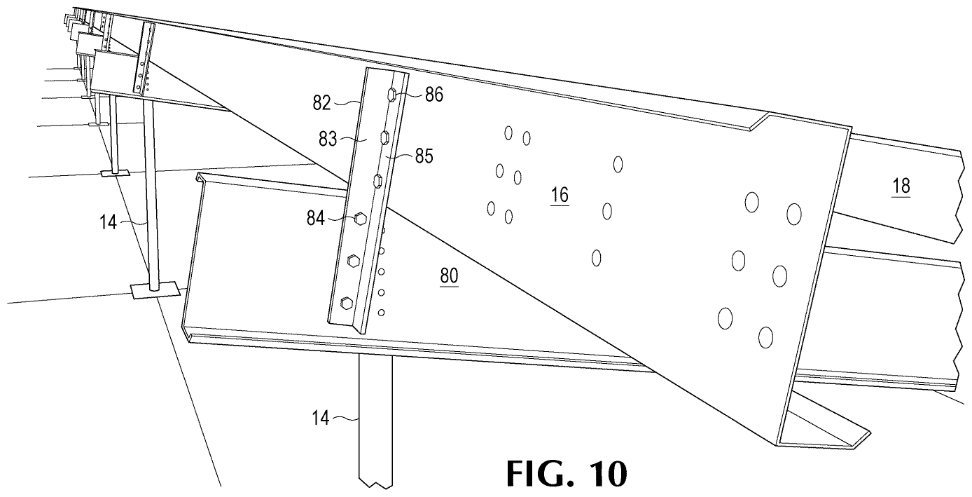

FIGS. 9 and 10 show an alternate substructure which eliminates the need for some of the standoffs 14, which beneficially improves access to the area beneath the substructure, allows for the rails to be positioned at a more arbitrary distance from each other, and permits arrays of larger dimensions. Specifically, a substructure may comprise at least one cross support 80 that supports more than one, and preferably at least three parallel rails 16, 18. The cross support 80 is preferably fashioned as a Z-shaped beam, similar to the rails 16, 18, and extends in a direction transversely perpendicular to the parallel rails 16, 18. The cross support 80 is preferably affixed to each of the rails 16, 18 by respective L-shaped support members 82 as described later.

The substructure shown in FIGS. 9 and 10 achieves a number of benefits. First, as just noted, the use of the cross support 80 provides sufficient structural support to the plurality of parallel rails 16, 18 that it eliminates the need for each rail to be supported by a standoff. Were the standoffs 14 to provide the sole support for the parallel rails 16, 18 then the solar array would require that adjacent standoffs be positioned at a relatively close distance to other to prevent the rails from bowing. The cross-support, conversely, provides much greater resistance to bowing, which means not only that fewer, more spaced apart standoffs may be used, but also that the positioning of the remaining standoffs becomes more flexible, meaning that the standoffs do not need to be positioned at a precise position, or necessarily evenly spaced along the rails. This makes the substructure, and the array as a whole, easier to assemble. Moreover, the parallel rails 16, 18 no longer need upper flanges tilted relative to the web to accommodate a desired pitch of the array (e.g., roof tilt). Instead, the cross supports 80 provide the necessary tilt simply by designing the heights of the respective standoffs 14, arranged across the length of each parallel rails 16, 17 to tilt the cross supports at the desired angle. For example, if mounted to a roof, the standoffs may be of equal length, such that the roof provides the incline to the cross supports 80. Conversely, if mounted to a level ground surface, the standoffs may be of respectively different heights to incline the cross supports 90, and therefore the mounted solar panels, with a desired tilt to more directly face the sun given the latitude of the installation. In this manner, the upper flanges of both the cross supports 80 and the rails 16, 18 may conveniently be perpendicular to their respective webs, rather than tilted at a custom angle.

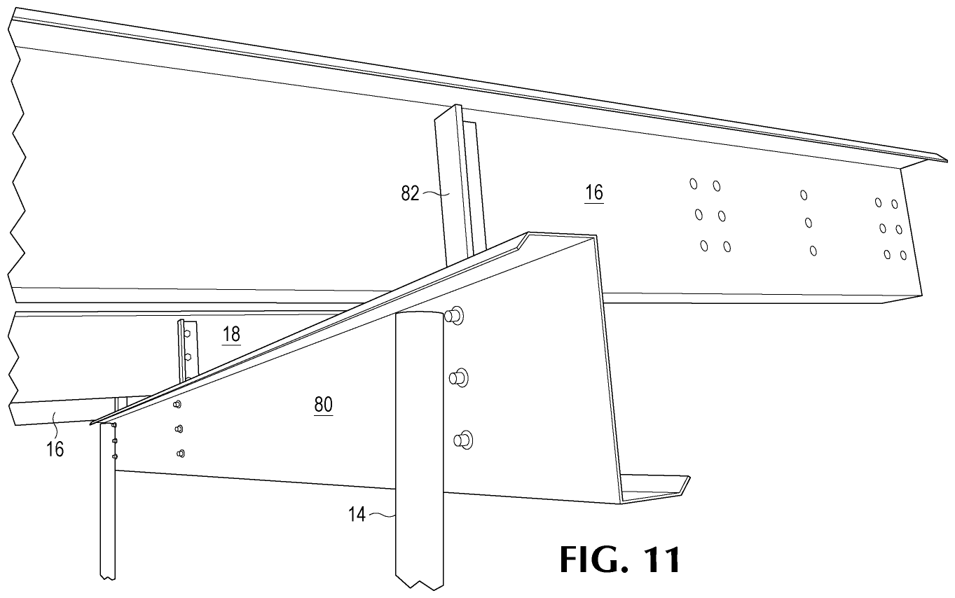

Each cross support 80 may be connected to the rails 16, 18 that it supports by respective elongate angle members 82. The angle members 82 may each be elongate members, made of iron, steel or other rigid material, with a generally L-shaped cross section defining two perpendicular faces. One of the perpendicular faces 83 may then be mounted flush with the cross support 80 while the other perpendicular face 85 may be mounted flush with a parallel rail 16, 18. As seen in FIG. 11, each face 83, 85 of the angle members 82 may define a respective set 84, 86 of apertures by which the angle members 82 may be securely fastened to the cross support 80 as well as the rails 16, 18. Also referring to FIG. 11, the cross support 80 is supported by a plurality of standoffs 14. Thus, the standoffs 14 rigidly support the cross supports 80, which in turn rigidly support the elongate rails 16, 18 via the angle members 82.

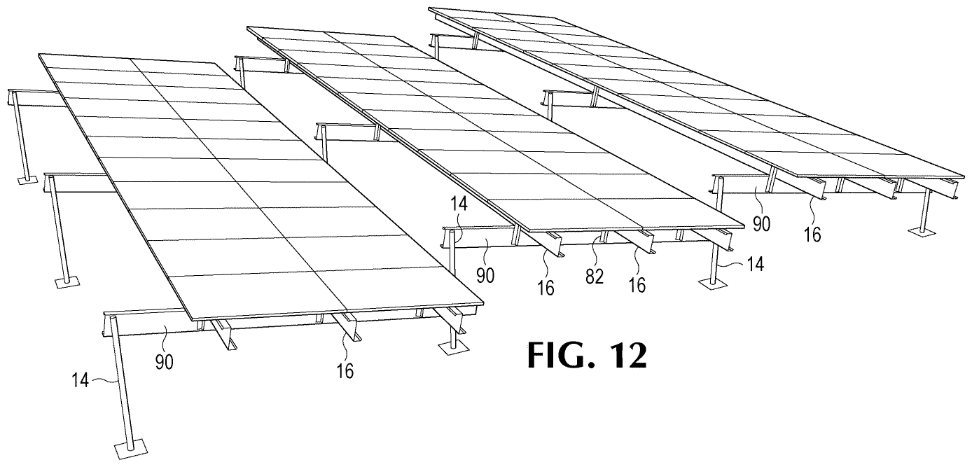

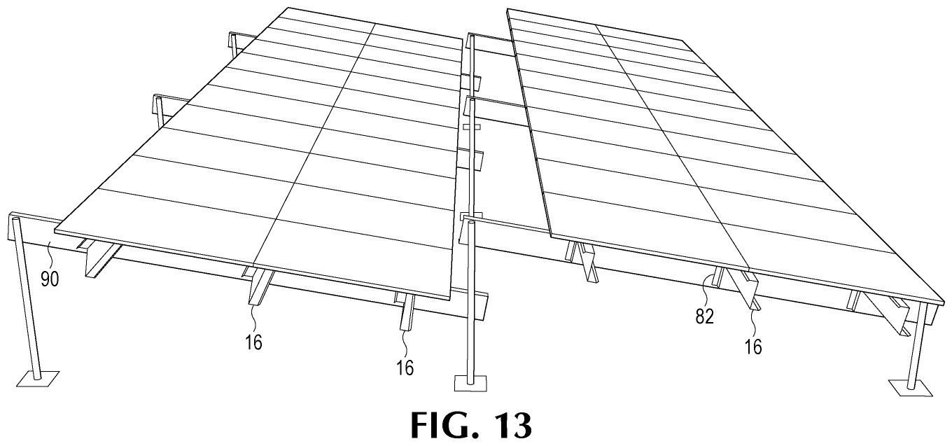

FIGS. 12 and 13 show a second alternate embodiment of a substructure for a solar panel array. Specifically, a substructure may comprise at least one cross support 90 that supports more than one, and preferably at least three parallel rails 16. Unlike the embodiments shown in FIGS. 9 and 10, there is no need for the cross support 90 to support a rail 18 that, in turn supports two solar panels across its section, as is seen in FIG. 1B, for example. Instead, the substructure of this embodiment includes a “straddle-rail” configuration with a first cross support 90 affixed to an upper portion of a standoff 14, and a second cross support 90 affixed to a lower portion of that standoff 14, but extending in a direction away of that of the other cross support 90 at the top of standoff 14. In this manner, multiples arrays 92, 94, 96 etc. may be easily connected in a field configuration, remaining as previously-described along the length of the rails 16 in the direction supporting the solar panels, but connecting front-to-back via a high/low connection on a standoff 14.

The cross support 90 may have a generally C-shaped cross section as depicted in FIGS. 12 and 13. Alternatively, the cross-support 90 be of a Z-shaped cross section as previously described in this specification, where the standoff 14 is placed on the side of the cross support 90 opposite that of the angle member 82, as is shown in FIG. 9 for example.

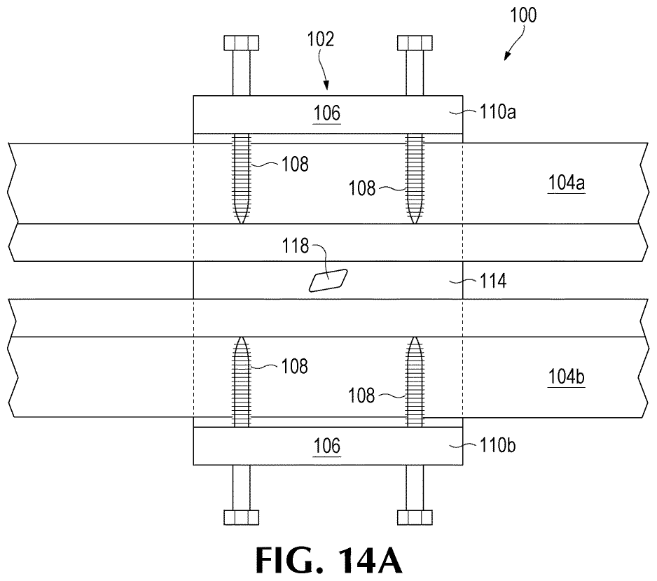

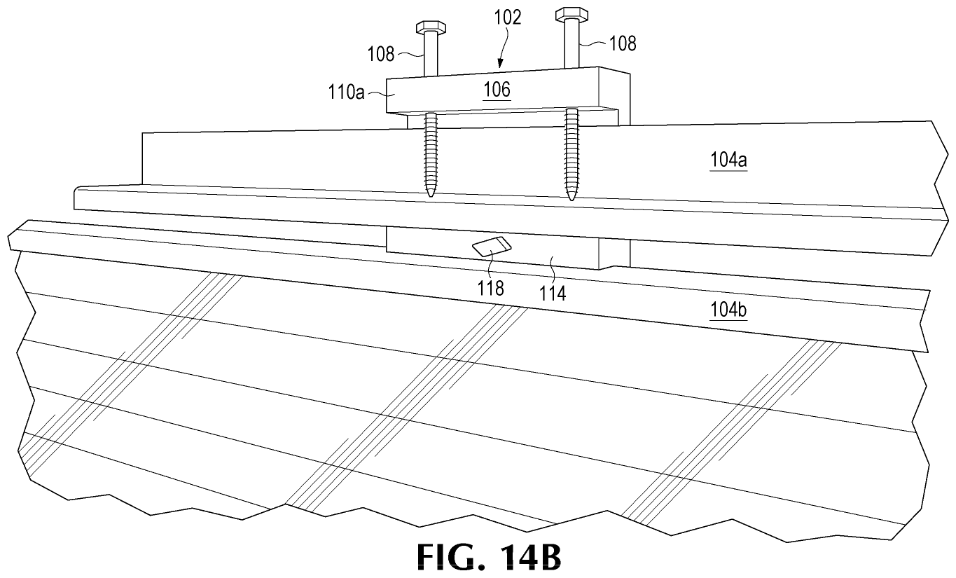

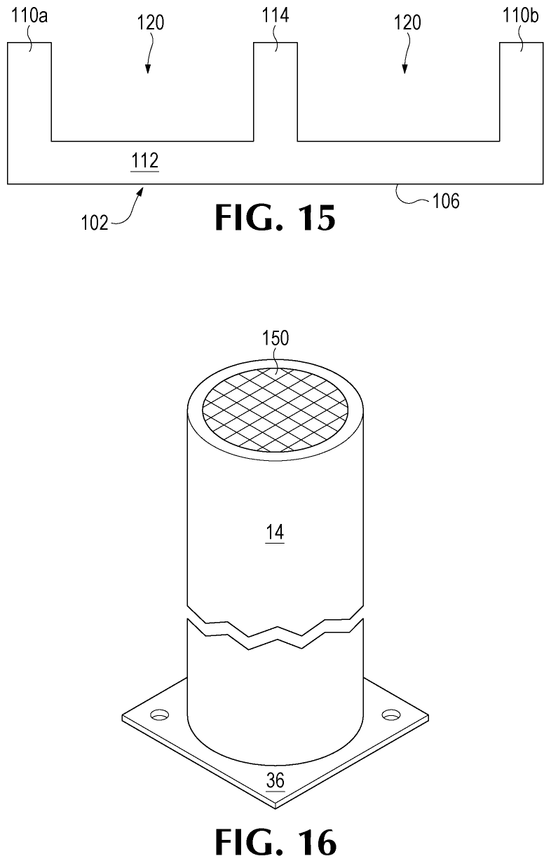

Referring to FIGS. 14A and 14 B, the present specification discloses a novel clamp system 100 comprising a clamp 102 that secures two frame members 104a, 104b to a rail member, such as the rails 16 or 18 previously described in this specification. The clamp 102 preferably includes a clamp body 106 and a plurality of securing members 108, shown in FIGS. 14A and 14B as bolts. FIG. 15 shows a cross section of the clamp body 106, which includes two arm members 110a, 110b at opposite ends of a base member 112, to form a generally E-shaped cross-section in profile. The clamp body also includes a central member 114. As can be seen in FIGS. 14A and 14B, in use, the clamp body 106 may be positioned relative to respectively adjacent peripheral sections of frame members 104a, 104b, which are generally rectangular in shape, such that the central member 114 is interposed between the inner-facing surfaces of the adjacent sections while each of the two arm members 106 is positioned next to an outer-facing surface of a respective frame section 104a, 104b. in other words, referring to FIG. 15, a peripheral section of each of the frame members 104a, 104b may be positioned in the channels 120 formed by the E-shaped clamp body 106. The clamp body may be secured to a rail (e.g., rail 16, 18) using a bolt 118.

As can easily be appreciated, to tighten or clamp the frame members 104a, 104b into place once these members are positioned relative to the clamp 102 as just described, the securing members 1-8 may be used to push the frame members against the central member 0104. Thus, where the securing members are threaded bolts as shown in the figures, these bolts may be turned to tightly engage the frame members 104a, 104b to the clamp 102, which as just noted is itself securely fastened to a rail. Specifically, in preferred embodiments, the central member 114 and the two arm members 110a, 110b preferably extend perpendicularly, in the same direction, away from the base member 112 by a distance less than a height of the frame members of the solar panel such that, when the solar panels are installed in their respective frames, the securing members may be accessible from beneath the solar panel to secure the frame members to the clamp. Those of ordinary skill in the art will appreciate that the securing members 108, while shown as bolts, may in alternate embodiments be any other member configured to push a peripheral section of a respective frame member away from an arm member 106 and towards the central member. For example, the securing members could be wedges or cams, that create separation between the frame member 104a, 104b and an arm member 106 as they are pushed laterally between the member 104a, 104b and an arm member 106.

Referring to FIG. 16, in some embodiments, one of more of the standoffs 14 and preferably all of the standoffs 14 may comprise a cylindrical tube filled with closed-cell foam to prevent water buildup from condensation, and also from water intrusion from the exterior of the pipe. This may be particularly important on roof-mounted installations where the standoffs 14 are connected to a roof in a manner aligned with a support of the roof to extend through a vapor barrier.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. An apparatus that secures at least one solar panel to a supporting surface, the apparatus comprising:
a plurality of rails, each comprising a beam having an upper flange supporting the at least one solar panel and a lower flange, the upper flange and the lower flange extending in opposite directions from a web that connects the upper flange to the lower flange;
a cross-support transverse to, and supporting, the plurality of rails;
a plurality of spaced apart, elongate standoffs supporting the cross support; where
the number of standoffs is less than the number of the plurality of rails.

2. The apparatus of claim 1 including a plurality of angle members, each rigidly securing the cross support to a respective one of the plurality of rails.

3. The apparatus of claim 2 where the plurality of angle members is greater than the number of standoffs.

4. The apparatus of claim 2 where each angle member includes a first face connected to, and oriented at a right angle to, a second face, the first face mounted flush with the cross support and the second face mounted flush with a respective rail.

5. The apparatus of claim 1 where the cross support is inclined.

6. The apparatus of claim 5 where the plurality of rails defines a top flange oriented perpendicular to a web.

7. An assembly for supporting an array of solar panels on a substructure comprising a plurality of beams spaced in a parallel relationship to each other and each beam held in an elevated position by a standoff, where at least one standoff supports a first beam at an upper portion of the standoff and a second beam at a portion of the standoff lower than the upper portion.

8. The assembly of claim 7 including a second standoff, where the second standoff supports a third beam at an upper portion of the second standoff and supports the first beam at a portion of the second standoff lower than the upper portion of the second standoff.

9. The assembly of claim 8 where the first beam and the second beam are angled relative to a supporting surface of the standoffs.

10. The assembly of claim 7 including a second standoff, where the second standoff supports a third beam at an lower portion of the second standoff and supports the first beam at a portion of the second standoff higher than the upper portion of the second standoff.

11. The assembly of claim 10 where the first beam and the second beam are angled relative to a supporting surface of the standoffs.

13. A clamp configured to attach two solar panels to a supporting substructure, the solar panels enclosed by a frame comprising a plurality of frame members arranged around the periphery of the solar panel, the clamp comprising:
a clamp body having a base member, a central member extending perpendicularly from the base member and two opposed arm members, each at a respective end of the base member and extending perpendicularly therefrom; and
a plurality of securing members together configured to be actuated to push a respective frame member of each of the two solar panels against the central member.

14. The clamp of claim 13 where the plurality of securing members are configured to be actuated to push a respective frame member of each of the two solar panels away from one of the two opposed arm members.

15. The clamp of claim 13 having a generally E-shaped cross section.
